(19) United States
(12) Patent Application Publication
(10) Pub. No.: US 2026/0225041 A1
(43) Pub. Date: Aug. 6, 2026

(54) MULTI-ELEMENT MEMBRANE ASSEMBLY FOR SELECTIVE CARBON CAPTURE

(71) Applicant: Valero Services, Inc., San Antonio, TX (US)

(72) Inventors: Michael A. Miller, Helotes, TX (US); Josh L. Mangum, Sarasota, FL (US)

(73) Assignee: Valero Services, Inc., San Antonio, TX (US)

(21) Appl. No.: 19/398,278

(22) Filed: Nov. 24, 2025

Related U.S. Application Data
(60) Provisional application No. 63/749,756, filed on Jan. 27, 2025.

(51) Int. Cl. B01D 63/08; B01D 53/22; B01D 65/00; B01D 67/00; B01D 69/02; B01D 71/02

(52) U.S. Cl. CPC B01D 63/084; B01D 53/228; B01D 63/081; B01D 65/003; B01D 67/00411; B01D 69/02; B01D 71/024; B01D 2257/504; B01D 2323/081; B01D 2325/04

(57) ABSTRACT

The present disclosure provides multi-element membrane assemblies for selective separation and capture of gaseous effluents. The assemblies may include stacked membrane units in, for example, either cubic or cylindrical configurations, providing high surface-area-to-volume ratios and thermal stability. The cubic configuration comprises flat membrane panels with metallic borders and support stringers, while the cylindrical configuration comprises toroid segments with thermally compatible gaskets. Both configurations maintain hermetic seals at elevated temperatures and provide efficient gas flow channels for feed and permeant gases. Manufacturing methods include pressing, casting, and additive manufacturing techniques. The assemblies are particularly suitable for separating carbon dioxide from high-temperature gas mixtures using lithium zirconate membranes.

### CROSS-REFERENCE TO RELATED APPLICATIONS

This application claims priority to U.S. Provisional Patent Application No. 63/749,756, filed January 27, 2025, the content of which is incorporated herein by reference in its entirety.

### FIELD

The present disclosure relates to gas separation technology, and more particularly to membrane assemblies for separating and capturing gaseous effluents such as carbon dioxide from high-temperature gas mixtures.

### BACKGROUND

Carbon capture and storage technology plays a crucial role in reducing greenhouse gas emissions. Various approaches have been investigated for separating carbon dioxide (CO₂) from gas mixtures, particularly from high-temperature industrial emissions.

Ionic solids, particularly lithium zirconate (Li₂ZrO₃ or LZO), have shown promise as solid-state membranes for CO₂ separation. LZO exhibits high chemical selectivity for CO₂ at elevated temperatures (e.g., approximately 650°C) through a chemisorption equilibrium reaction that produces lithium carbonate (Li₂CO₃) and zirconate (ZrO₂).

However, significant challenges exist in implementing LZO-based membranes in industrial settings. Key among these challenges are the manufacturability of mechanically, thermally, and chemically durable LZO-based membranes and scalable methods for constructing practical assemblies that implement this membrane material for use with high temperature effluents.

Therefore, there exists a need for the development of advanced materials and assemblies for a more efficient implementation of LZO-based solid-state membranes into CO₂ separation processes.

### BRIEF SUMMARY

The present disclosure addresses this need by providing multi-element membrane assemblies having high surface-area-to-volume ratio and thermal stability for the selective separation and capture of CO₂.

Accordingly, provided herein is a multi-element membrane assembly for selective separation and capture of CO₂ from gaseous effluents, the assembly comprising: a plurality of stacked membrane units forming an integrated assembly; wherein each membrane unit comprises a membrane material selective for carbon dioxide; and wherein said membrane units are hermetically sealed relative to each other. In some embodiments, the membrane material comprises lithium zirconate.

In a first aspect of the multi-element membrane assembly, the membrane units are flat membrane panels stacked parallelly in a cubic configuration creating orthogonal flow channels for feed gas and permeant gas. In some embodiments, the assembly further comprises metallic borders surrounding the flat panels; support stringers; and a metallic supporting frame. In some embodiments, the metallic borders are formed by at least one of: pressing membrane material into pre-formed metallic borders; fusing metallic borders to membrane edges via powder sintering; and selective laser sintering. In some embodiments, the support stringers are arranged to minimize flow resistance while maximizing structural support.

In a second aspect of the multi-element membrane assembly, the membrane units of the multi-element membrane assembly are toroid segments stacked in a cylindrical configuration. In some embodiments, the cylindrical configuration provides hermetic sealing at sustained temperatures of at least 700°C. In some embodiments, the toroid segments have a square cross-section optimized for gas flow characteristics and structural integrity. In some embodiments, the assembly further comprises thermally compatible gaskets between the toroid segments; a compression fixture; and thermal expansion compensation features. In some embodiments, the compression fixture comprises: a bottom end-plate with a sweep gas inlet; a coaxial tensioning rod; a top plate assembly comprising a tensioning mechanism and a permeant outlet; and a tensioning spring connecting the tensioning rod to the tensioning mechanism. In some embodiments, the thermally compatible gaskets comprise at least one of: large-grain graphite; natural minerals; glass composite fiber matts; ceramic composite fiber matts; and composite metal matrices.

In some embodiments that may be combined with any of the foregoing, the membrane units are manufactured by at least one of: casting; uniaxial pressing; molding; additive manufacturing; photolithographic additive manufacturing; and tape casting. In some embodiments, the membrane units are joined by at least one of: welding; bolting; high-temperature compatible adhesives; and metal powder thermal brazing. In some embodiments, the membrane material exhibits chemical selectivity for carbon dioxide at temperatures of about 650°C. In some embodiments, the membrane units comprise a membrane thickness between about 1.0 mm and about 5.0 mm and achieve a carbon dioxide separation efficiency of at least 90% at operational temperature.

Further provided is a method of manufacturing a multi-element membrane assembly, the method comprising: forming membrane units through a manufacturing process; heat treating the membrane units; adding sealing elements to said membrane units; stacking said units in a selected configuration; joining said units to form an integrated assembly; and annealing the integrated assembly. In some embodiments of the method, the membrane units are flat membrane panels stacked parallelly in a cubic configuration creating orthogonal flow channels for feed gas and permeant gas. In some embodiments, the membrane units are toroid segments stacked in a cylindrical configuration. In some embodiments, forming membrane units comprises: combining membrane powder with metallic border material; pressing the combination at elevated temperature; and sintering the pressed combination. In some embodiments, heat treating and annealing comprises: heating to a temperature between 600°C and 1010°C; and maintaining said temperature for a predetermined time period. In some embodiments, the method further comprises: attaching support stringers to membrane surfaces; and activating brazing powder to bond said support stringers.

Additionally, the disclosure provides a fixture for assembling a cylindrical multi-element membrane assembly, the fixture comprising: means for applying uniform compressive load across stacked membrane segments; means for compensating for thermal expansion; means for conveying feed gas mixture; and means for collecting permeant gas.

Unless defined otherwise, the term “about,” particularly in reference to a given quantity, is meant to encompass deviations of plus or minus ten percent.

### BRIEF DESCRIPTION OF THE DRAWINGS

FIG. 1 illustrates a schematic of a cubic multi-element membrane assembly showing stacked membrane panels and gas flow channels.

FIG. 2 illustrates a schematic of a cylindrical multi-element membrane assembly showing the stacked toroid configuration and mechanical fixture arrangement. Left panel shows unit membrane assemblies comprising toroid membrane segments and sealing gaskets. Right panel shows unit membrane assemblies stacked to form a segmented membrane of predetermined length and aspect ratio under compressive load using a mechanical fixture.

FIG. 3 shows an exemplary process flow diagram for manufacturing a cubic multi-element membrane assembly.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides solutions for constructing efficient gas separation membrane assemblies. The described assemblies overcome traditional limitations in high-temperature gas separation applications through advanced design features and manufacturing methods. The disclosure encompasses, for example, two configurations: a cubic assembly and a cylindrical assembly. The cubic configuration utilizes stacked flat membrane panels with metallic borders, creating orthogonal gas flow channels for efficient separation. The cylindrical configuration employs stacked toroid segments with square cross-sections, allowing for customizable length-to-diameter ratios while maintaining separation efficiency.

Both configurations incorporate novel sealing mechanisms that maintain hermetic isolation between feed and permeant gases at elevated temperatures up to 700°C. The assemblies achieve high surface-area-to-volume ratios through their modular design while incorporating thermal expansion compensation features and structural support elements.

The disclosure further provides comprehensive manufacturing methods utilizing various techniques including casting, pressing, additive manufacturing, and combinations thereof. These methods enable scalable production while maintaining precise control over critical parameters such as membrane thickness, border integrity, and seal effectiveness.

Additionally, the disclosure includes specialized fixture designs for assembly and operation, particularly for the cylindrical configuration. These fixtures provide uniform compressive loading, thermal expansion compensation, and gas flow control while maintaining seal integrity at elevated temperatures.

### Multi-Element Membrane Assembly

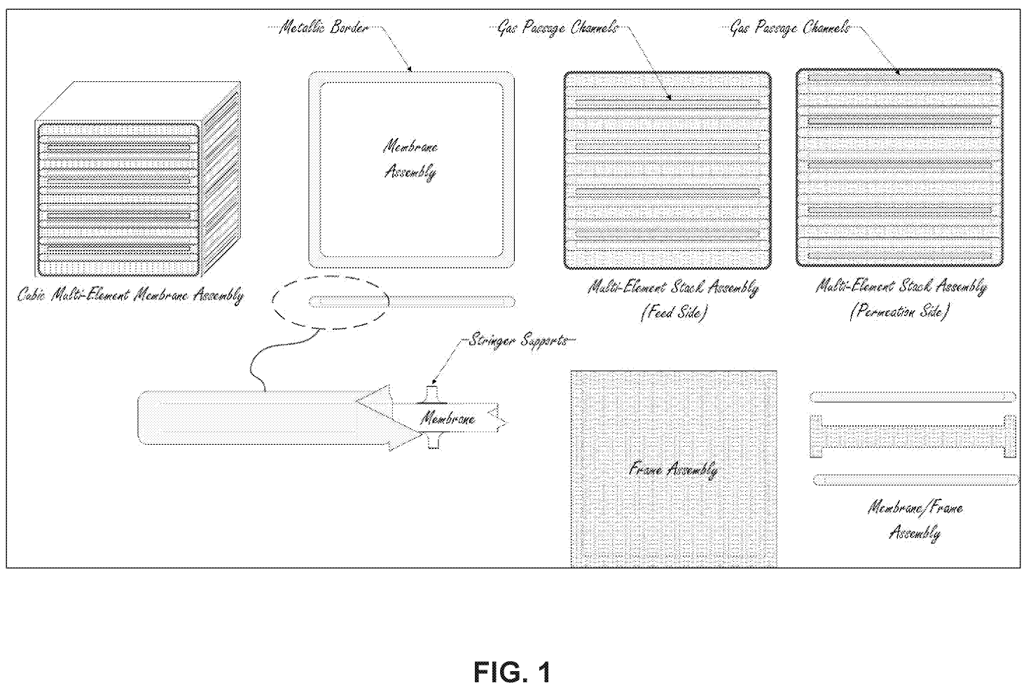

In one embodiment of the disclosure useful in forming a cubic construct, a unit membrane assembly consists of two flat membrane panels each one with a surrounding metallic border, support stringers (as needed), and a metallic supporting frame. As illustrated in FIG. 1, unit membrane assemblies may be welded or bolted together to form a stack of predetermined height. In doing so, the stacked assembly on one face of the cubic structure forms thin channels as gas passages for the feed gas (i.e., source or effluent gas mixture) while the adjacent face forms thin channels as gas passages for the permeant (i.e., separated CO₂) and sweep gases flowing in an orthogonal direction relative to the feed gas. In each case, the hermetic seal formed by the welded or gasketed membrane assembly inhibits passive diffusion or leakage of a gas mixture between the feed and permeant channels even at elevated temperature. Inadequate sealing at elevated temperature would otherwise result in poor selectivity performance of the membrane assembly.

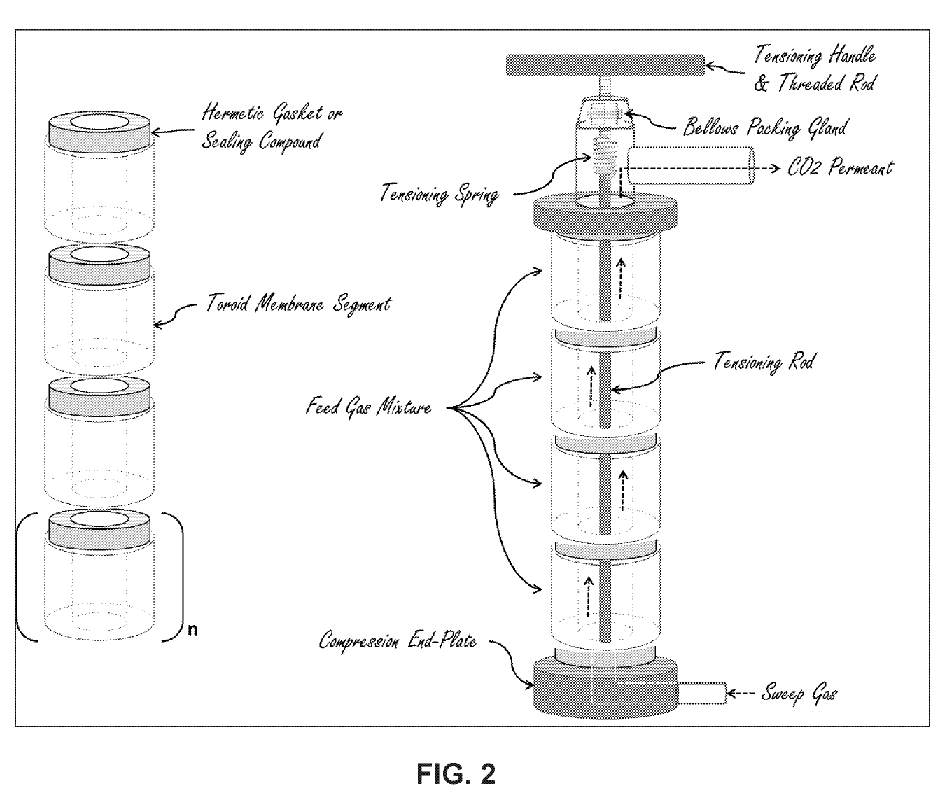

In a second embodiment useful in forming a cylindrical membrane of any desired length-to-diameter aspect ratio, a unit membrane assembly consists of a toroid with square cross section and a thermally compatible gasket set upon one face of the toroid. As illustrated in FIG. 2, unit membrane assemblies are stacked to form a segmented cylindrical membrane of predetermined length wherein each unit segment is hermetically sealed on each face by the gasket joining each segment such that passive diffusion or leakage of the source gas mixture through the structure is greatly inhibited even at elevated temperatures.

Various methods may be employed to confine the stacked assembly into a mechanically robust whole-body construct. Such methods include, but are not limited to, the use of high-temperature compatible and hermetic joining materials that are composed of, for example, ceramic precursor bonding adhesives or metal powder thermal brazing compounds, to join unit membranes to each other.

Alternatively, a mechanical fixture may be employed in conjunction with suitable gasket materials to apply a uniform compressive load against the stacked assembly and thus providing sufficient force to cause the gasket material between each unit segment to seal each segment interface hermetically (FIG. 2). The compositions of suitable gasket materials for this arrangement are known to those familiar with the art of hermetic sealing materials or appliances with high-temperature compatibility including, but are not limited to, large-grain graphite, natural minerals, glass or ceramic composite fiber matts, or composite metal matrices.

### Manufacturing Methods

A membrane panel or toroid may be formed by various means such as, but not limited to, casting, uniaxial pressing, molding, additive manufacturing (AM), photolithographic AM, or tape casting. In the case of the cubic configuration assembly, the metallic border surrounding each panel may be formed mechanically by pressing or casting the membrane material into a pre-formed metallic border, or by fusing it to the edges of the membrane panel via powder sintering or by an AM process such as selective laser sintering (SLS).

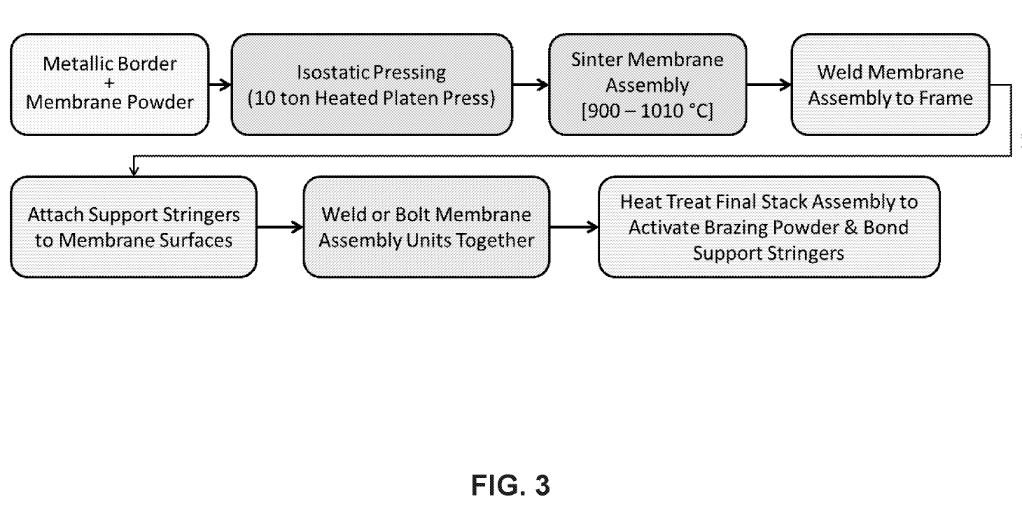

Not to be limited by any manufacturing process, FIG. 3 illustrates an exemplary process flow diagram for the manufacture of a cubic multi-element membrane assembly. In this example, membrane panels can be manufactured by pressing membrane powder formulations and a metallic border in one step, followed by heat treating (e.g., sintering) the pressed panel in a separate step.

Unit membrane assemblies are then formed and welded or bolted together to construct a cubic stack with thin channels as gas passages for feed and sweep gases. Finally, the stack assembly is heat treated to activate the brazing powder used to fuse the support stringers to the membrane panels, thus providing structural support to each membrane panel.

### Fixture for Assembly of Segmented Cylindrical Membranes

In the cylindrical configuration of the multi-element membrane assembly, the fixture for constructing a segmented and stacked cylindrical membrane, as illustrated in FIG. 2, may adopt a plurality of configurations, any of which would lead to the fundamental premise that the fixture design must provide or meet the following functionality or criteria:

A fixture that applies uniform compressive load across all unit membrane segments (toroids) in the stacked assembly of predetermined length and aspect ratio such that a hermetic seal is achieved between all unit segments up to sustained temperatures of at least 700°C.

An implement to apply and set the compressive load required to hermetically seal all unit segments in the stacked assembly of predetermined length or aspect ratio.

A feature to compensate for the coefficient of thermal expansion of the membrane material within each segment by limiting the compressive load across all unit membrane segments such than the load does not exceed the compressive strength of the membrane segment.

An outlet for permeant gas (e.g., CO₂) or, alternatively, an inlet for a feed gas mixture.

A gas inlet that enables a desired sweep gas (e.g., Ar, N₂, or He) to flow along the entire length of the stacked assembly’s internal space, entraining with it the permeant gas.

Alternatively, the provision for a sweep gas inlet may be eliminated and, in its place, an external vacuum source connected to the permeant gas outlet may be employed.

Not to be limited by any one design or configuration, the segmented and stacked cylindrical membrane assembly illustrated on FIG. 2 is one of a plurality of exemplar designs that satisfies the above said functionality and criteria. In the present exemplar design, the assembly fixture consists of a bottom end-plate that accommodates a sweep gas inlet machined into the plate, and a coaxial rod that is threaded or welded to the end-plate. A tensioning mechanism (handle and threaded rod), a hermetically sealed bellows gland packing, and a permeant outlet comprise the top plate assembly. The coaxial rod and tensioning mechanism are connected together by a tensioning spring. For assembly, unit membranes of a predetermined number are stacked between the end-plate and the top plate assembly such that the tensioning rod runs coaxially through each unit membrane. The stacked assembly is then placed under compressive load by turning the tensioning handle on the top assembly until a predefined load is achieved across the stacked membrane assembly.

The materials of construction for the end-plate, tensioning rod, tensioning spring, and top assembly must be stable at sustained temperatures of at least 700°C. Suitable materials for this assembly include, but are not limited to, 316L stainless steel, nickel-based super alloys, and zirconium.

### EXAMPLES

The following examples are offered to illustrate provided embodiments and are not intended to limit the scope of the present disclosure.

### Example 1: Cubic Assembly Manufacturing and Testing

A cubic multi-element membrane assembly can be manufactured following the process described in this disclosure. The membrane material is prepared by combining 80wt.% LZO powder with a median particle size of 1-3 micrometers, 13.3 wt.% octamethyl polyhedral oligomeric silsesquioxane (OM-POSS), 0.2mL tetraethyl orthosilicate (TEOS) per gram of LZO, 0.2mL of a 4 vol.% solution of dimethyldichlorosilane (DMDCS) in chloroform per gram of LZO, and fumed silica (6.7wt.%) as a structural reinforcement. These ingredients are thoroughly blended initially to form a homogeneous viscous paste and then milled into a coarse powder suitable for further processing.

A metallic border material of 316L stainless steel is placed on a heated platen press, providing lateral confinement of the powder mixture within the border area and between the platens during the subsequent pressing process. The powder mixture is spread out evenly within the confines of the border and then pressed in place at 10 tons of load while the heated platen press is maintained at 60°C. The pressed panels are then allowed to cure at room temperature for 48 hours to form a dense and rigid green body.

The cured panel with its integrated metallic border is then sintered in air at a controlled heating rate (3 °C/min) up to 650°C for 4 hours, resulting in a final membrane, 3mm thick, that is hydrophobic and ~80% dense of theoretical.

Depending on the final panel thickness and area, support stringers can be attached to a panel using a commercial titanium-based brazing compound, brazed at 1,000°C under an inert atmosphere. The completed panels are assembled into a 10-layer stack by welding the metallic border of each membrane panel to the metallic assembly.

### Example 2: Cylindrical Assembly Performance Evaluation

A cylindrical assembly was constructed using 15 toroid segments, each with an outer diameter of 76mm, height of 5.1mm, and wall thickness of 10mm. The segments were manufactured using a tape casting process that achieved uniform thickness of 5.1mm. Vermiculite-based gaskets with a thickness of 1mm were used between segments.

The assembly was mounted in the disclosed fixture system and compressed to 871 N using the integrated tensioning mechanism. When tested at 650°C with a feed gas flow rate of 2 standard liters per minute, the assembly maintained stable performance throughout the testing period (~72 hours of continuous operation). Fourier Transform Infrared (FTIR) spectroscopy and mass spectrometry analyses of the permeate stream measured a steady-state CO₂ flux of 25mg/(m2⋅s) with purity exceeding 95%.

871 N using the integrated tensioning mechanism. When tested at 650°C with a feed gas flow rate of 2 standard liters per minute, the assembly maintained stable performance throughout the testing period (~72 hours of continuous operation). Fourier Transform Infrared (FTIR) spectroscopy and mass spectrometry analyses of the permeate stream measured a steady-state CO₂ flux of 25mg/(m²⋅s) with purity exceeding 95%.

Taken together, the examples demonstrate implementation of using the disclosed compositions and methods for multi-element membrane assemblies designed for high-temperature gas separation. The examples are demonstrative of both cubic and cylindrical configurations, validating effective CO₂ separation performance for the cylindrical configuration. The manufacturing methods, including pressing, casting, and brazing processes, produced robust assemblies with excellent mechanical stability and hermetic sealing at room temperature. These results confirm the practical viability of the disclosure for industrial-scale carbon capture applications using LZO-based membrane systems.

What is claimed is:

1. A multi-element membrane assembly for selective separation and capture of carbon dioxide from gaseous effluents, the assembly comprising:
a plurality of stacked membrane units forming an integrated assembly;
wherein each membrane unit comprises a membrane material selective for carbon dioxide; and
wherein said membrane units are hermetically sealed relative to each other.

2. The assembly of claim 1, wherein the membrane material comprises lithium zirconate.

3. The assembly of claim 1, wherein the membrane units are flat membrane panels stacked parallelly in a cubic configuration creating orthogonal flow channels for feed gas and permeant gas.

4. The assembly of claim 3, further comprising metallic borders surrounding the flat panels; support stringers; and a metallic supporting frame.

5. The assembly of claim 4, wherein the metallic borders are formed by at least one of: pressing membrane material into pre-formed metallic borders; fusing metallic borders to membrane edges via powder sintering; and selective laser sintering.

6. The assembly of claim 4, wherein the support stringers are arranged to minimize flow resistance while maximizing structural support.

7. The assembly of claim 1, wherein the membrane units are toroid segments stacked in a cylindrical configuration.

8. The assembly of claim 7, wherein the cylindrical configuration provides hermetic sealing at room temperature and high CO₂ selectivity at sustained temperatures of at least 700°C.

9. The assembly of claim 7, wherein the toroid segments have a square cross-section optimized for gas flow characteristics and structural integrity.

10. The assembly of claim 7, further comprising thermally compatible gaskets between the toroid segments; a compression fixture; and thermal expansion compensation features.

11. The assembly of claim 10, wherein the compression fixture comprises: a bottom end-plate with a sweep gas inlet; a coaxial tensioning rod; a top plate assembly comprising a tensioning mechanism and a permeant outlet; and a tensioning spring connecting the tensioning rod to the tensioning mechanism.

12. The assembly of claim 10, wherein the thermally compatible gaskets comprise at least one of: large-grain graphite; natural minerals; glass composite fiber matts; ceramic composite fiber matts; and composite metal matrices.

13. The assembly of claim 1, wherein the membrane units are manufactured by at least one of: casting; uniaxial pressing; molding; additive manufacturing; photolithographic additive manufacturing; and tape casting.

14. The assembly of claim 1, wherein the membrane units are joined by at least one of: welding; bolting; high-temperature compatible adhesives; and metal powder thermal brazing.

15. The assembly of claim 1, wherein the membrane material exhibits chemical selectivity for carbon dioxide at temperatures of about 650°C.

16. The assembly of claim 1, wherein the membrane units comprise a membrane thickness between about 1 mm and about 10 mm and achieve a carbon dioxide separation efficiency of at least 90% at operational temperature.

17. A method of manufacturing a multi-element membrane assembly, the method comprising: forming membrane units through a manufacturing process; adding sealing elements to said membrane units; stacking said units in a selected configuration; joining said units to form an integrated assembly; and heat treating the integrated assembly.

18. The method of claim 17, wherein the membrane units are flat membrane panels stacked parallelly in a cubic configuration creating orthogonal flow channels for feed gas and permeant gas.

19. The method of claim 17, wherein the membrane units are toroid segments stacked in a cylindrical configuration.

20. The method of claim 17, wherein forming membrane units comprises: combining membrane powder with metallic border material; pressing the combination at elevated temperature; and sintering the pressed combination.

21. The method of claim 17, wherein heat treating comprises: heating to a temperature between 650°C and 1010°C; and maintaining said temperature for a predetermined time period.

22. The method of claim 17, further comprising: attaching support stringers to membrane surfaces; and activating brazing powder to bond said support stringers.

23. A fixture for assembling a cylindrical multi-element membrane assembly, the fixture comprising: means for applying uniform compressive load across stacked membrane segments; means for compensating for thermal expansion; means for conveying feed gas mixture; and means for collecting permeant gas.
